(19) United States
(12) Patent Application Publication
(10) Pub. No.: US 2013/0337216 A1
(43) Pub. Date: Dec. 19, 2013

(54) OPTICAL DISC

(71) Applicants: Yasunobu Higashika, Kofu-shi (JP); Takao Tagiri, Kofu-shi (JP)

(72) Inventors: Yasunobu Higashika, Kofu-shi (JP); Takao Tagiri, Kofu-shi (JP)

(73) Assignee: Pioneer Corporation, Kanagawa (JP)

(21) Appl. No.: 13/981,528

(22) PCT Filed: Jan. 27, 2011
(86) PCT No.: PCT/JP2011/051574

§ 371 Date: Sep. 5, 2013

(51) Int. Cl. G11B 7/24038

(52) U.S. Cl. CPC G11B 7/24038
USPC 428/64.4

(57) ABSTRACT

In an optical disc including a discoid optical-disc substrate and a coating film formed on the optical-disc substrate, the optical-disc substrate includes a first region including the innermost periphery thereof and having a projection formed on the whole of the first region, and a second region located outside of the first region. The coating layer is formed on the second region. Before the coating film is formed, the thickness of the optical-disc substrate at the first region is greater than the thickness of the optical-disc substrate at the second region. After the coating film is formed, the total thickness of the optical-disc substrate at the second region and the coating film is greater than the thickness of the optical-disc substrate at the first region.

### TECHNICAL FIELD OF THE INVENTION

The present invention relates to optical discs in which information can be stored using light-beam irradiation, or from information can be played back using light-beam irradiation. More particularly, the present invention relates to optical discs each having a rich coating film formed on its substrate.

### BACKGROUND ART

There are known methods of centering an optical disc for clamping it, one of which is illustrated in FIG. 1, and another of which is illustrated in FIG. 2.

The centering method, referred to as the first method, illustrated in FIG. 1 uses a clamp mechanism equipped with a tapered centering projection 22 mounted on the center portion of a disc table 21 on which an optical disc is mountable. In this centering method, the inner peripheral edge 1a, i.e. the bottom edge of the inner periphery, of the center hole of an optical disc 1 abuts on a taper surface 22a of the centering projection 22 so as to be limited. This results in the optical disc 1 being centered. Thereafter, the optical disc 1 is clamped by a support member 21a of the disc table 21.

The centering method, referred to as the second method, illustrated in FIG. 2 uses a clamp mechanism equipped with a centering projection 22 mounted on the center portion of a disc table 21 on which an optical disc is mountable. The centering portion 22 has engagement hooks 23 formed on the outer periphery thereof to project therefrom. In this centering method, when an optical disc 1 is clamped by a support member 21a of a disc table 21, the inner peripheral edge 1a, i.e. the bottom edge of the inner periphery, of the center hole of the optical disc 1 is so engaged with the engagement hooks 23 of the centering projection 22 as to be limited. This results in the optical disc 1 being centered.

For example, Blu-ray discs (BDs) are used as the optical discs 1 illustrated in FIGS. 1 and 2. Reference numeral 3 represents a disc substrate, and reference numeral 4 represents a coating film consisting of a cover layer and the like.

Next-generation optical discs are required to be more densified than BDs. For such a requirement, there are known multilayered optical discs each having multi recording layers. The applicant of the present application discloses multilayered optical discs in a first patent document.

### CITATION LIST

### Patent Document

First patent document: International Publication NO. WO/2009/037773

### DISCLOSURE OF THE INVENTION

### Problem to be Solved by the Invention

Next-generation optical discs, each of which has multi recording layers, are expected to have a rich coating film containing a cover layer and a spacer layer. There may be problems using the known centering layers set forth above for centering such an optical disc having a rich coating film.

For the first method, because the coating film 4 of such an optical disc 1A has a thickness greater than a thickness of the coating film of a normal optical disc, such as 100 μm of the coating film of a BD, the surface of the optical disc 1A to be clamped by the support member 21a may abut on the support member 21a before the inner peripheral edge 1a abuts on the taper surface 22a (see FIG. 3). This may cause a gap between the inner peripheral edge 1a and the taper surface 22a, resulting in the centering being difficult.

For the second method, because the coating film 4 of such an optical disc 1A has a thickness greater than a thickness of the coating film of a normal disc, such as 100 μm of the coating film of a BD, the inner peripheral edge 1a, i.e. the bottom edge of the inner periphery, of the center hole of the optical disc 1A may not be engaged with the engagement hooks 23 of the centering projection 22 (see FIG. 4). This may result in the centering being difficult.

Such an optical disc with the coating film greater in thickness than the coating film of a normal optical disc has a longer distance between the inner peripheral edge and the surface to be clamped. For this reason, these known centering methods using the respective clamp mechanisms cannot stably center such an optical disc with the coating film greater in thickness than the coating film of a normal optical disc, resulting in eccentricity of the optical disc.

The present invention has been made in view of the aforementioned circumstances, and has an example of a purpose of stably centering an optical disc with a coating film greater in thickness than that of a normal optical disc using the known centering methods based on the respective known clamp mechanisms set forth above.

### Means for Solving the Problem

In order to achieve such a purpose provided above, a first aspect of the present invention is an optical disc. The optical disc includes a discoid optical-disc substrate, and a coating film formed on the optical-disc substrate. The optical-disc substrate includes a first region including an innermost periphery and having a projection formed on a whole of the first region, and a second region located outside of the first region, the coating layer being formed on the second region. Before the coating film is formed, a thickness of the optical-disc substrate at the first region is higher than a thickness of the optical-disc substrate at the second region. After the coating film is formed, a total thickness of the optical-disc substrate at the second region and the coating film is equal to or higher than the thickness of the optical-disc substrate at the first region.

### BRIEF DESCRIPTION OF THE DRAWINGS

FIG. 1 is a view illustrating a first centering method for clamping a normal optical disc;

FIG. 2 is a view illustrating a second centering method for clamping a normal optical disc;

FIG. 3 is a view showing that there is a problem in the first centering method if the coating film of an optical disc has a thickness greater than a thickness of the coating film of a normal optical disc;

FIG. 4 is a view showing that there is a problem in the second centering method if the coating film of an optical disc has a thickness greater than a thickness of the coating film of a normal optical disc;

FIG. 5 is a schematic cross sectional view of an optical disc according to an embodiment of the present invention;

FIG. 6 is a view illustrating how the optical disc is centered based on the first centering method;

FIG. 7 is a view illustrating how the optical disc is centered based on the first centering method;

FIG. 8 is a partially broken-away perspective view schematically illustrating a multilayered optical disc as an example of the optical discs according to the embodiment of the present invention; and

FIG. 9 is a cross sectional view taken on line A-A of FIG. 8.

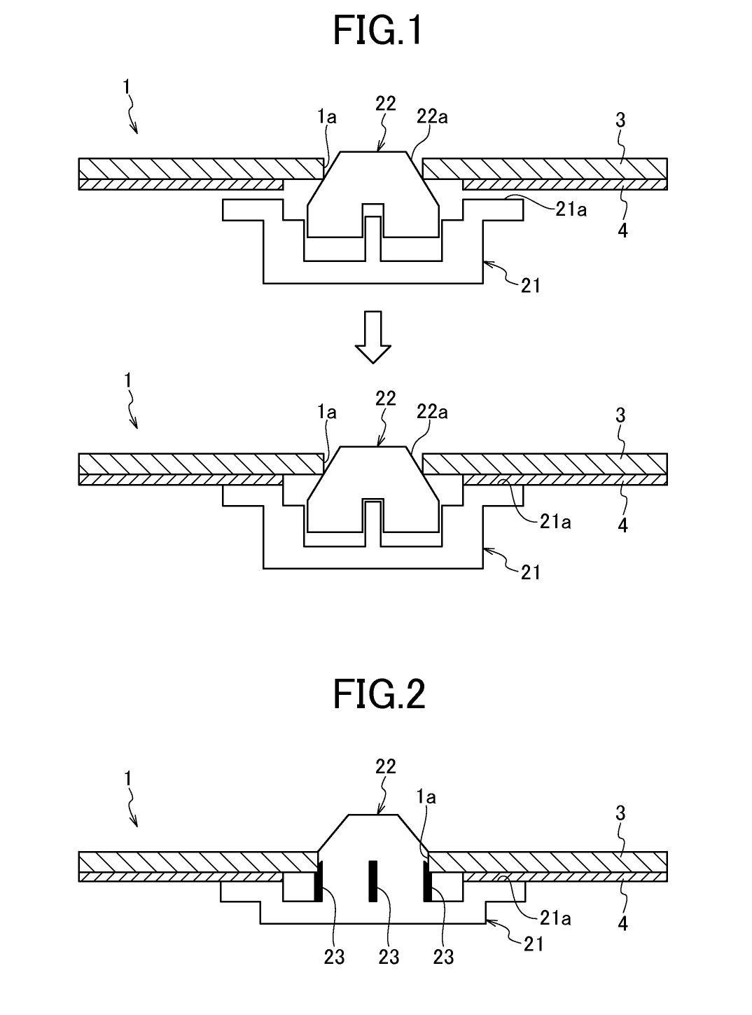

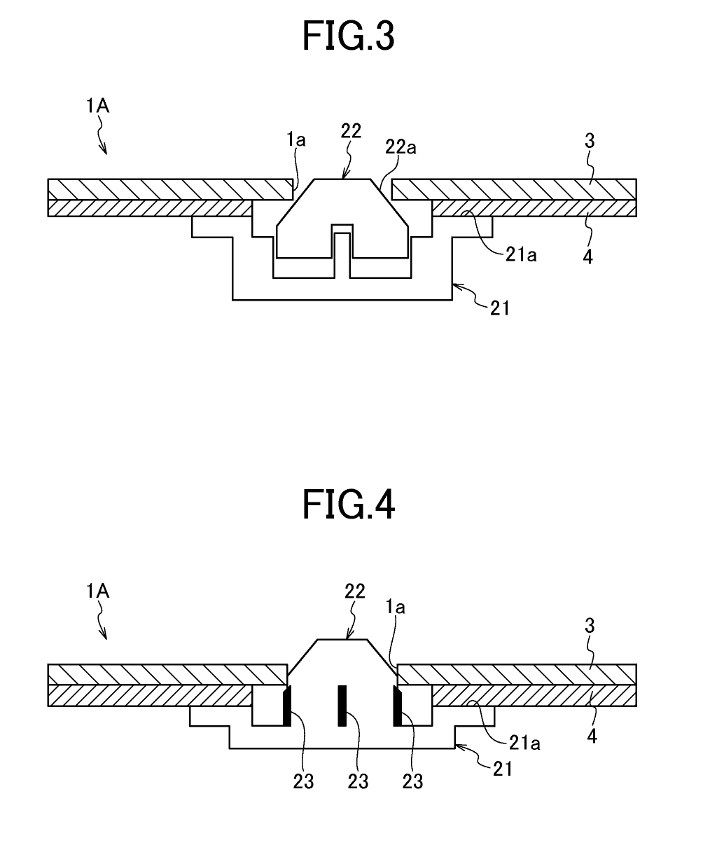

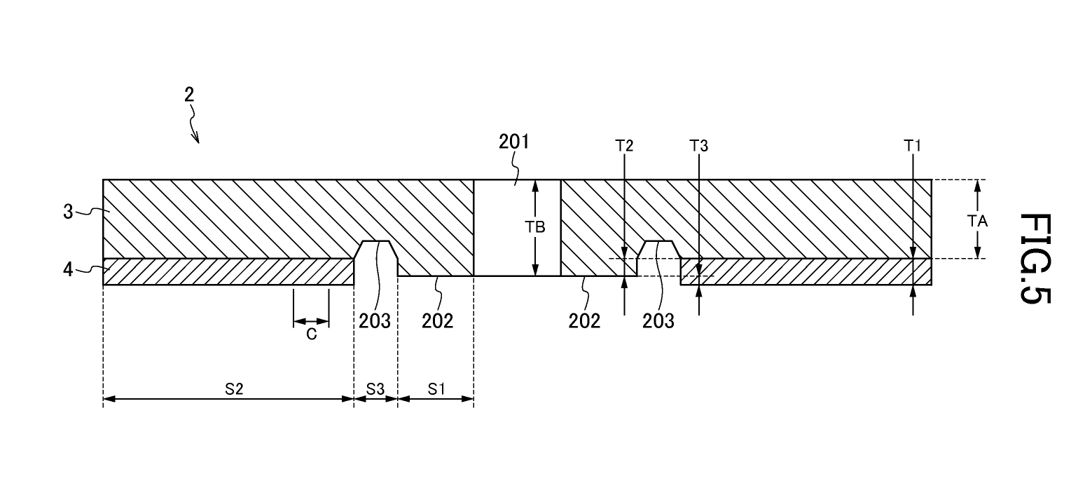

### EMBODIMENT FOR CARRYING OUT THE INVENTION

An embodiment of the present invention will be described hereinafter with reference to the drawings.

FIG. 5 is a schematic cross sectional view of an optical disc 2 according to an embodiment of the present invention. The optical disc 2 is comprised of a coating film 4 having a thickness greater than a thickness of the coating film of a normal optical disc, such as 100 μm of the coating film of a BD. As the optical disc 2 can be designed as, for example, a next-generation optical disc having multi recording layers.

The optical disc 2 is comprised of an optical-disc substrate 3 designed as a discoid transparent substrate, and the coating film 4. The optical-disc substrate 3 has a center hole formed through the center portion thereof. The coating film 4 is formed on one major surface of the optical-disc substrate 3 by spin coating.

The one major surface of the optical-disc substrate 3 has first, second, and third partitioned regions, referred to first, second, and third regions S1, S2, and S3. The first region S1 has an annular projection 202 formed on an inner peripheral part of the one major surface containing the innermost periphery. The second region S2 is a part of the one major surface located outside of the first region S1. On the second region S2, the coating film 4 is formed. The third region S3 is designed as a concaved stamper-holding hook 203 formed on the one major surface between the first region Si and the second region S2. A clamp area C to be mounted on a support member 21a of a disc table 21 is located on the one major surface within the range from the position, which is 22 mm radially apart from the innermost periphery of the optical disc 2, to the position, which is 33 mm radially away therefrom. In this embodiment, the clamp area C is located within the second region S2.

In this embodiment, the optical-disc substrate 3 has a thickness TB at the first region S1 is greater, i.e. higher, than a thickness TA thereof at the second region S2. That is, in the optical disc 2, before application of the coating film 4 thereon, the thickness TB is greater than the thickness TA.

In this embodiment, the sum of the thickness of the optical disc 3 at the second region S2 and the thickness of the coating film 4 is equal to or greater, i.e. higher, than the thickness TB of the optical disc 3 at the first region S1. Specifically, the following relation equation is satisfied in the optical disc 1 after application of the coating film 4 thereon:

T3=T1−T2≧0

where: T1 is the thickness of the coating film 4, T2 is the height of the projection 202 defined by the subtraction of TA from TB, i.e. “TB−TA”, and T3 is the difference between the sum of the thickness of the optical disc 3 at the second region S2 and the thickness of the coating film 4 and the thickness TB of the optical-disc substrate 3 at the first region S1.

In this embodiment, the inventor's experiments revealed that the thickness T3 was suitable within the range from 0 to 20 μm.

As described above, even if the coating film 4 of the optical disc 2 has a greater thickness, the projection 202 formed on the inner peripheral part of the optical-disc substrate 3 results in reduction of the thickness T3. This makes possible that the known centering methods based on the respective known clamp mechanisms stably center the optical disc 2. In other words, the optical disc 2 according to this embodiment is designed to be applicable to the available optical-disc drive devices, so that it has a high level of compatibility with other optical discs.

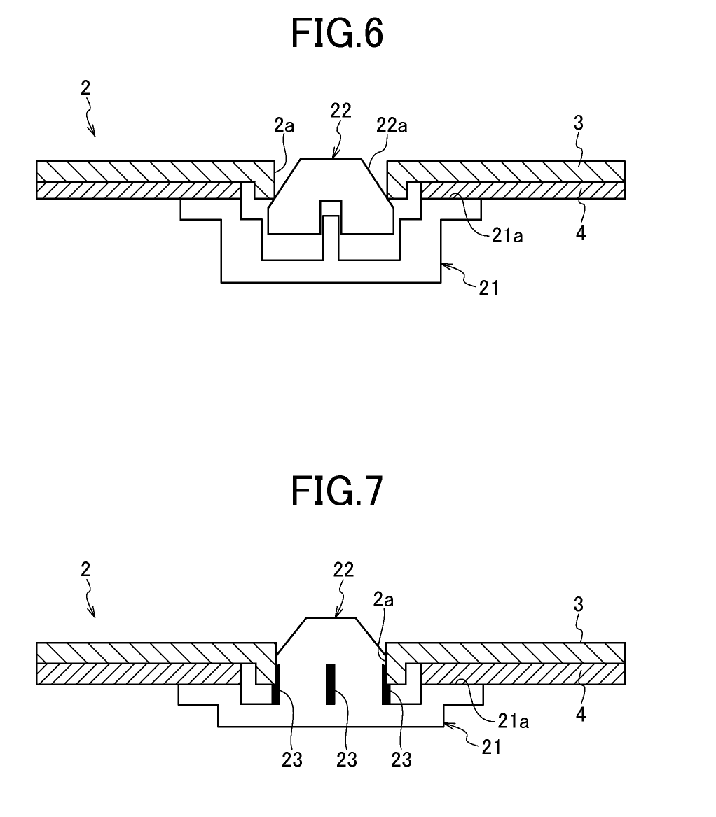

FIG. 6 schematically illustrates how the optical disc 2 is centered based on the first method set forth above. Referring to FIG. 6, the inner peripheral edge 2a abuts on the taper surface 22a so as to be limited even if the coating film 4 is thicker than a normal one, making it possible to center the optical disc 2.

FIG. 7 schematically illustrates how the optical disc 2 is centered based on the second method set forth above. Referring to FIG. 7, the inner peripheral edge 2a is so engaged with the engagement hooks 23 as to be limited even if the coating film 4 is thicker than a normal one, making it possible to center the optical disc 2.

As illustrated in FIGS. 5 to 7, the optical disc 2 according to this embodiment is comprised of the concaved stamper-holding hook 203 formed on the optical-disc substrate 3; the concaved stamper-holding hook 203 separates the projection 202 of the optical-disc substrate 2 and the coating film 4. However, the optical disc 2 is not limited to the structure. Specifically, the optical disc 2 can be configured such that the optical-disc substrate 3 is flat to have no concaved stamper-holding hooks 203. In each of the optical disc 2 with the concaved stamper-holding hook 203 and that with no concaved stamper-holding hooks 203, the projection 202 is preferably formed between the innermost periphery and an inner edge of the clamp area C.

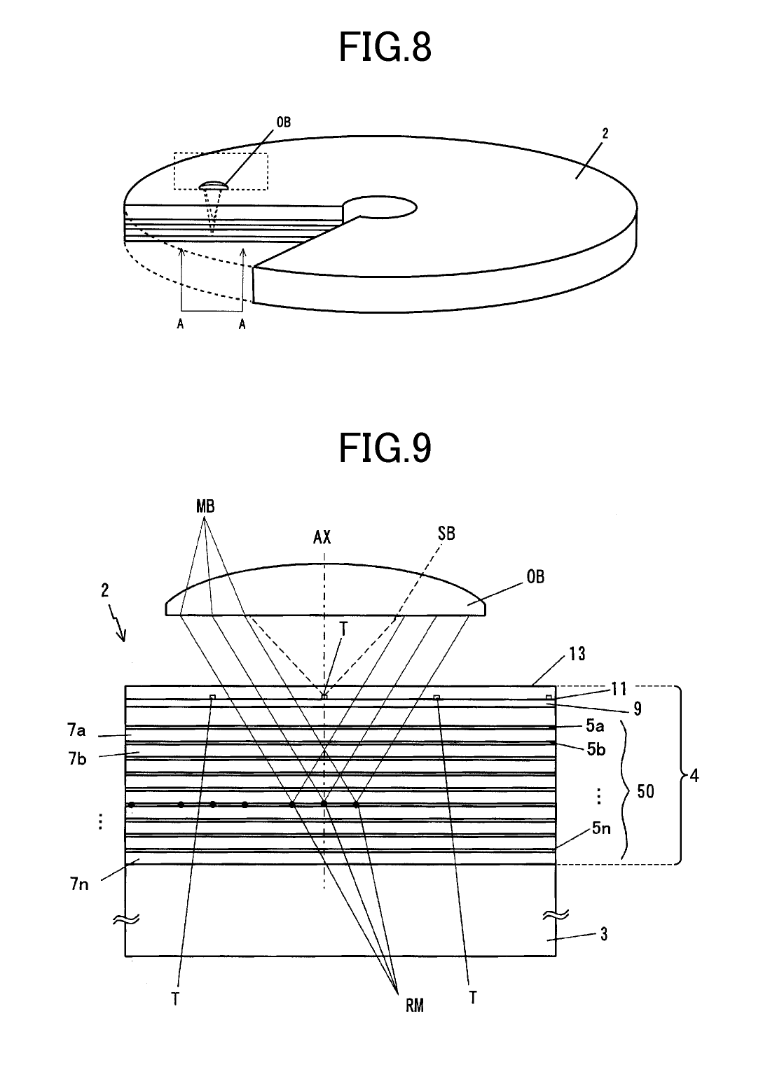

FIG. 8 is a perspective view of a multilayered optical disc as an example of the optical disc 2, and FIG. 9 is a cross sectional view taken on line A-A in FIG. 8. The optical disc 2 is a multilayered optical disc as a multilayered recording medium including multi recoding layers laminated in its film-thickness direction; the multi recording layers are made from multiphoton absorptive materials with refractive-index change characteristics. The optical disc 2 is comprised of, in sequence from its incident side of a main optical beam MB and a servo optical beam SB, a cover layer 13, a guide layer 11, a reflection-wavelength selective reflective film 9 for the main optical beam MB and the servo optical beam SB, a recording-layer stack 50, and an optical-disc substrate, i.e. a base substrate, 3. The coating film 4 illustrated in FIGS. 5 to 7 corresponds to the laminate of the cover layer 13, the guide layer 11, the reflection-wavelength selective reflective film 9, and the recording-layer stack 50.

The cover layer 13 is made from organic or inorganic light-transmissive materials, such as transparent resin materials. The cover layer 13 works to make flat the laminated optical disc 2, and protect the recording-layer stack 50.

The guide layer 11 has a track T formed to detect focusing and tracking servo signals based on the serve optical beam SB.

The recording-layer stack 50 is the stack of a plurality of recording layers 5, each of which is capable of recording information.

The reflection-wavelength selective reflective film 9 located between the guide layer 11 and the recording-layer stack 50 is designed to reflect the serve optical beam SB having a first wavelength different from a second wavelength of the main optical beam MB, and allow the main optical beam MB to pass therethrough. If the guide layer serves as a reflection-wavelength selective layer, the reflection-wavelength selective reflective film 9 can be eliminated.

The main optical beam MB, which has a predetermined positional relationship with respect to the servo optical beam SB, is focused by an objective lens OB, so that the focused points of the main optical beam on each recording layer of the recording-layer stack 50 three-dimensionally record pieces of data thereon as recorded marks RM. The objective lens OB, which has a predetermined numerical aperture, is operative to irradiate the focused beam, and collect reflected beams from the recording-layer stack 50. The focused beam is irradiated from the side of the cover layer 13 to write data into or read data from a specified recording layer, so that recording or playback of information is carried out.

The optical-disc substrate, i.e. the protective substrate, 3 is made from, for example, a glass material, a plastic material, an ultraviolet curable acrylic resin, or other similar materials. As the plastic material, a polycarbonate material, an amorphous polyolefin material, a polyimide material, a PET material, a PEN material, a PES material, or the like can be used.

Note that, in this embodiment, a multilayered optical disc has been described as an example of the optical discs 2 according to the present invention, but the optical discs 2 according to the present invention are not limited thereto.

Specifically, the present invention can be applied to various structures of optical discs each having a coating film 4 thicker than that of normal optical discs. For example, the present invention can be applied to one-layer optical discs.

As described above, the optical disc 2 according to this embodiment is comprised of the discoid optical-disc substrate 3, and the coating film 4 formed on the optical-disc substrate 3. One major surface of the optical-disc substrate 3 has at least the first and second regions S1 and S2. The first region S1 has the annular projection 202 formed on the inner peripheral part of the one major surface containing the innermost periphery. The second region S2 is a part of the one major surface located outside of the first region S1. On the second region S2, the coating film 4 is formed.

Before application of the coating film 4 on the optical-disc substrate 3, the thickness TB of the optical-disc substrate 3 at the first region S1 is greater than the thickness TA of the optical-disc substrate 3 at the second region S2. The sum of the thickness TA of the optical disc 3 at the second region S2 and the thickness T1 of the coating film 4 is equal to or greater, i.e. higher, than the thickness TB of the optical disc 3 at the first region S1 after application of the coating film 4 on the second region S2.

The configuration of the optical disc 2 makes it possible for each of the first and second methods, i.e. centering methods using a corresponding one of the known clamp mechanisms, to stably center the optical disc 2.

After the coat film 4 is formed on the optical-disc substrate 3, the difference T3 between the total thickness of the optical-disc substrate 3 at the second region S2 and the coating film 4 and the thickness of the optical-disc substrate 3 at the first region S1 is preferably set to be within the range from 0 to 200 μm.

In this structure, even if the coating film has a greater thickness, the difference T3 having a suitable value set forth above results in reduction of the difference in height between the inner peripheral part on which the projection 202 is formed and the outer peripheral part on which the coating film 4 is formed. This makes it possible to stably center the optical disc 2.

Preferably, the clamp area C is arranged within the second region S2.

In this arrangement, the optical disc 2 can be applied to available optical disc drive devices.

It is more preferable that the third region S3, which is designed as a concaved stamper-holding hook 203, is formed between the first and second regions S1 and S2, resulting in separation of the projection 202 of the first region Si and the coating layer 4 on the second region S2.

This structure can be preferably applied to optical discs 2 each having a stamper-holding hook 203 on the corresponding optical-disc substrate 3.

The present invention is not limited to the embodiment set forth above, and the embodiment of the present invention can be deformed or modified within the scope of the present invention. Such deformations or modifications based on the embodiment can be within the technical range of the present invention.

### DESCRIPTION OF CHARACTERS

1, 2 Optical disc

Optical-disc substrate

4 Coating film

201 Center hole

202 Projection

203 Stamper-holding hook

S1 First region

S2 Second region

S3 Third region

TA Thickness of the outer peripheral part of an optical disc

TB Thickness of the inner peripheral part of an optical disc

T1 Thickness of the coating film

T2 Height of the projection

T3 Difference between the inner peripheral part and the outer peripheral part of an optical disc

C Clamp area

1-5. (canceled)

6. An optical disc comprising:
a discoid optical-disc substrate; and
a coating film formed on the optical-disc substrate,
wherein the optical-disc substrate comprises:
a first region including an innermost periphery of the optical-disc substrate and having a projection formed on a whole of the first region; and
a second region located outside of the first region, the coating layer being formed on the second region, and
before the coating film is formed, a thickness of the optical-disc substrate at the first region is greater than a thickness of the optical-disc substrate at the second region, and
after the coating film is formed, a total thickness of the optical-disc substrate at the second region and the coating film is greater than the thickness of the optical-disc substrate at the first region.

7. The optical disc according to claim 6, wherein, after the coating film is formed, a difference between the total thickness of the optical-disc substrate at the second region and the coating film and the thickness of the optical-disc substrate at the first region is set to be equal to or less than 200 μm.

8. The optical disc according to claim 6, wherein a clamp area to be supported by an optical disc drive device is located within the second region.

9. The optical disc according to claim 6, wherein the optical-disc substrate comprises a concaved portion formed between the first region and the second region, the concaved portion separating the projection of the first region from the coating film formed on the second region.

10. The optical disc according to claim 6, wherein a side surface of the innermost periphery of the first region is parallel to a thickness direction of the optical-disc substrate.
